(19) United States
(12) Patent Application Publication
(10) Pub. No.: US 2006/0116898 A1
(43) Pub. Date: Jun. 1, 2006

(54) Interactive risk management system and method with reputation risk management

(76) Inventor: Gary Edward Peterson, Ridgewood, NJ (US)

Correspondence Address: ABELMAN, FRAYNE & SCHWAB, 666 THIRD AVENUE, 10TH FLOOR, NEW YORK, NY, 10017, US

(21) Appl. No.: 11/223,468

(22) Filed: Sep. 9, 2005

Related U.S. Application Data
(63) Continuation-in-part of application No. 10/716,893, filed on Nov. 18, 2003.
(63) Continuation-in-part of application No. 10/868,484, filed on Jun. 14, 2004.
(60) Provisional application No. 60/608,971, filed on Sep. 9, 2004.

(51) Int. Cl. G06Q 99/00

(52) U.S. Cl. 705/1

(57) ABSTRACT

An interactive risk management system and method using reputation risk reduction and an impact measurement analysis matrix are used for a business or other organization to generate a graphic display to the user, through the browser, to display a mapping of processes used in conducting the business or the affairs of the organization and allow the user to selectively view additional data, such as messages describing risks associated with the process selected. The user may navigate thorough and among the processes to access and review associated data, allowing the user to gain information about selected processes and associated risks. Metrics are used for evaluating a likelihood of reputation risk.

### CROSS-REFERENCE TO RELATED APPLICATIONS

This application is a continuation-in-part of U.S. application Ser. No. 10/716,893, filed on Nov. 18, 2003; and Ser. No. 10/868,484, filed on Jun. 14, 2004, each of which is incorporated herein by reference in their entirety. This application is also based on U.S. provisional application No. 60/608,971, filed Sep. 9, 2004, now abandoned, which is incorporated herein by reference in its entirety.

### BACKGROUND OF THE INVENTION

1. Field of the Invention

This invention relates to process management, and in particular to an interactive display which provides information for management processes and associated risks.

2. Description of the Related Art

Enterprise reputation risk presents management challenges. Even the finest organization's reputation may suffer serious and even irreparable damage from many disparate causes. Over the past years, risk controls were directed at capital losses arising from trading, market and credit risk. But today, the profound risk which must be identified, mitigated, controlled, and monitored is Enterprise Reputation Risk. Reputation risk may include the loss of shareholder value resulting from a lack of customer and public trust and confidence in the organization, must be effectively managed. Such reputation risk may result in a measurable, negative impact on the financial performance of the organization on a short-term or long-term basis, and/or in an impact on the going-forward value of a brand or franchise associated with the organization, such as the underlying value of the brand or franchise is threatened in a material manner.

Reputation risk is very difficult to manage since it may be extremely complex to identify and manage. It requires a coordinated analysis and control of three separate, interrelated risks: business risk, regulatory risk and operational risk. It also requires the identification of sub-risks which may occur throughout any part of an organization: within or between front, back and middle offices, and even between the organization and outsource providers. It also requires the insertion of key controls and monitors, often in areas which have not been previously identified as key control points.

Few organizations have risk reduction methodologies in place across all areas or for all risk areas. Thus, reputation risk remains. For example, organizations such as banks which will follow the Basel II formula, set forth by the Basel Committee on Banking Supervision through the Basel Capital Accord, are already well aware of the limits and complexity of the Basel II methodology. Its principal focus is reducing Operational Risk, and it specifically excludes an analysis of many overlapping areas of risk which give rise to enterprise reputation risk, so the reduction of reputation risk via Basel II is limited.

Business Process Management (BPM) methods also reduce reputation risk, but only to a degree. A high quality BPM methodology yields measures and controls which give to management a set of metrics to manage in a cost effective and process efficient manner. However, BPM is, at heart, directed to cost control and efficiency rather than real risk reduction. In other words, an organization may spend millions on effective BPM and still have substantial exposure to reputation risk.

Thus, effective reputation risk management depends upon identifying risk and control at each process point. However, because of downsizing, rightsizing, mergers, acquisitions, technology implementations, and outsourcing, organizations find an enormous disconnect between their process and controls. For example, the planned control environment instituted at some past time does not conform to the process which has been implemented to meet business and service demands. This means that risk remains in the organization.

Process management and risk reduction may be even more complex for organizations which have implemented Basel II or Business Process Management (“BPM”). Basel II's operational risk definition is very limited and overlapping areas of risk may not be considered in the analysis. This leaves wide gaps and vulnerabilities. In addition, organizations which have implemented BPM may have effectively “mapped processes” and inserted control measures to maximize efficiency and cost reduction, but the underlying analysis of reputation risk factors is rarely accomplished. Thus, in both cases, management is left with a false sense of security.

Reputation risk arises when a situation, occurrence, business practice, or event has the potential to materially influence the perceived trust and confidence of the public or of stakeholders in an institution, resulting in a measurable, negative impact on financial performance on a short-term or long-term basis; resulting in an impact on the going-forward value of the brand or franchise, such that the underlying value of the brand or franchise is threatened in a material manner; and/or resulting in a change in fundamental business practices is required in order to mitigate or resolve the risk.

It has been found that, as a basis of measurable, negative impact, events associated with reputation risk result in an almost immediate decrease in market capitalization of about 20% to about 25% of share value, which generally continues until at least the third factor set forth in the definition; that is, a change in fundamental business practices, is in place and perceived by stakeholders to be effective.

A need exists for the creation of an ongoing method of effective control and monitoring of process and risk management in an organization.

It is therefore an object of the present invention to provide an interactive risk management system and method to allow a user to navigate from process to process to access and review associated data, to thereby obtain information about selected processes and associated risks.

### BRIEF SUMMARY OF THE INVENTION

The invention comprises an interactive risk management system and method implemented via a computer and monitor that displays to the user through the browser a multi-dimensional visual mapping of the processes of an organization, and allows the user to selectively view additional data, such as messages describing risks associated with the selected process. The user may navigate from one process to another process to access and review associated data, allowing the user to gain information about selected processes and associated risks. Metrics are used for evaluating a likelihood of reputation risk.

### BRIEF DESCRIPTION OF THE SEVERAL VIEWS OF THE DRAWINGS

Preferred embodiments of the invention are disclosed hereinbelow with reference to the drawings, wherein:

Preferred embodiments of the invention are described hereinbelow with reference to the drawings, wherein:

FIG. 1 is a schematic illustration of the interactive management system in accordance with the present invention;

FIG. 2 is a schematic illustration of a mapping;

FIG. 3 is a flowchart of the method of operation of the interactive management system of FIG. 1;

FIG. 4 is a display screen displaying a mapping;

FIG. 5 is the display screen of FIG. 4 with a pop-up information window;

FIG. 6 is a display screen displaying an alternative embodiment of a mapping;

FIG. 7 is a display screen displaying a modification of the mapping of FIG. 6;

FIG. 8 is a display screen displaying another modification of the mapping of FIG. 6;

FIG. 9 is a display screen displaying another embodiment of the mappings, showing the use of yield sign indicators;

FIG. 10 is a display screen displaying a list of accessible reports, with the list being accessed from a yield sign indicator in FIG. 9;

FIG. 11 is a display screen displaying a first report;

FIG. 12 is a display screen displaying a second report;

FIG. 13 is a flowchart of the operation of the system for performing reputation risk management;

FIG. 14 is a flowchart of the methodology of the reputation risk identification process;

FIG. 15 is an impact measurement analysis matrix for risk factors;

FIG. 16 is an example filled-in impact measurement analysis matrix; and

FIG. 17 is an impact measurement analysis matrix industry factors.

### DETAILED DESCRIPTION OF THE INVENTION

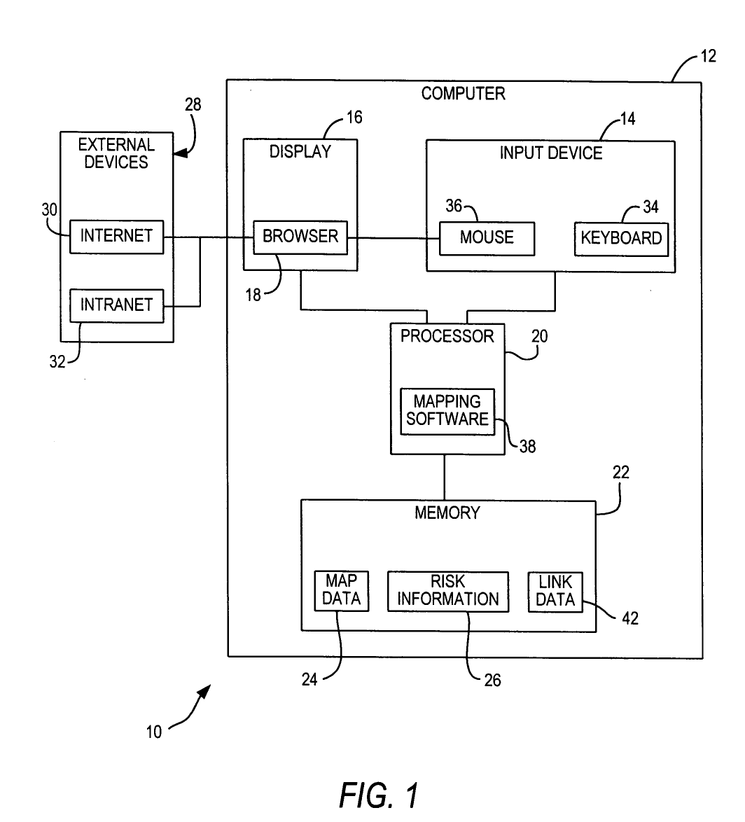

As shown in FIGS. 1-8, an interactive risk management system 10 and method are described which visually display to the user, for example, via a computer monitor utilizing a browser, a mapping of processes of an organization, that allows the user to selectively view additional data, such as messages describing risks associated with any selected process. The interactive risk management system 10 and method may be sold or otherwise provided to users as a software application associated with the trademark “COOL” commercially available from “IMAG” and/or other entities providing the interactive risk management system 10 and method.

The user may navigate or move from process to process, for example, by use of the computer mouse or its equivalent, to access and review associated data, allowing the user to view, on screen or via a printout, information about selected processes and associated risks.

In one representative embodiment, an accounts officer of a bank may move through a series of displayed processes representing steps in the procedures of the bank, such as a new-accounts procedure for creating a new banking account for an applicant, or a loan approval procedure for a potential borrower. For each process, the accounts officer may view instructions, guidelines, policies, and risks associated with the process currently being reviewed, such as the bank's approved procedures for preventing money laundering.

The displayed processes may include actuatable display regions or icons so that when the accounts officer clicks the region with a mouse cursor, a hyperlink to additional information is activated by which the computer system retrieves the correspondingly hyperlinked information and displays it to the accounts officer. The linked information may be, for example, a pre-existing text of the warning signs to be noted by the accounts officer which indicates a money-laundering risk associated with the application or applicant being reviewed. The linked information may be displayed to the accounts officer through the browser, for example, as a separate web-page on the intranet of the bank, or in a pop-up dialog box displayed over the existing browser text.

In another representative embodiment, a medical technician in a hospital may move through a series of displayed processes representing steps in the procedures for performing diagnostic tests for patients, such as procedures implementing test requests from doctors and test approval from a health management organization (HMO) for performing X-ray or chemotherapy on a patient. At each process step, the medical technician may view instructions, guidelines, policies, and risks associated with the current process being reviewed, for example, the hospital's approved procedures for preventing unnecessary medical tests. The displayed processes may include actuatable display regions or icons so that when the medical technician clicks the region with a mouse cursor, a hyperlink to additional information is activated by the computer system to retrieve the correspondingly hyperlinked information, and to display this information to the medical technician. The linked information may be, for example, a pre-existing text of the warning signs to be noted by the medical technician which suggest medical fraud by a patient and/or a doctor. The linked information may be displayed to the medical technician through the browser, for example, as a separate web-page on the intranet of the hospital or in a pop-up dialog box displayed over the existing browser text.

As shown in FIG. 1, the interactive management system 10 and method includes a computer 12 having an input device 14, a display 16 for displaying a graphic user interface (GUI) including a browser 18, a processor 20, and a memory 22 for storing a mapping such as map data 24 comprising a plurality of processes and for storing at least one risk message or information 26 associated with at least one of the plurality of processes. The display 16 presents the browser 18 and GUI to the user and communicates with external devices 28 such as the Internet 30 or an intranet 32 associated with the organization implementing the interactive management system 10 and method.

The input device 14 may include a keyboard 34 and a mouse 36 for using the browser 18. Alternatively, the input device 14 and the display 16 may include a touch screen system (not shown) to be employed for inputs and outputs. The processor 20 operates the browser 18 and receives signals such as mouse input signals indicating actuation of icons or other actuatable display regions of the browser 18 by the user using the mouse 36. The processor 20 also uses mapping software 38 such as graphics software or any other software, for example, graphics software available from “MICROSOFT CORPORATION” commercially available under the trademark “MICROSOFT VISIO”.

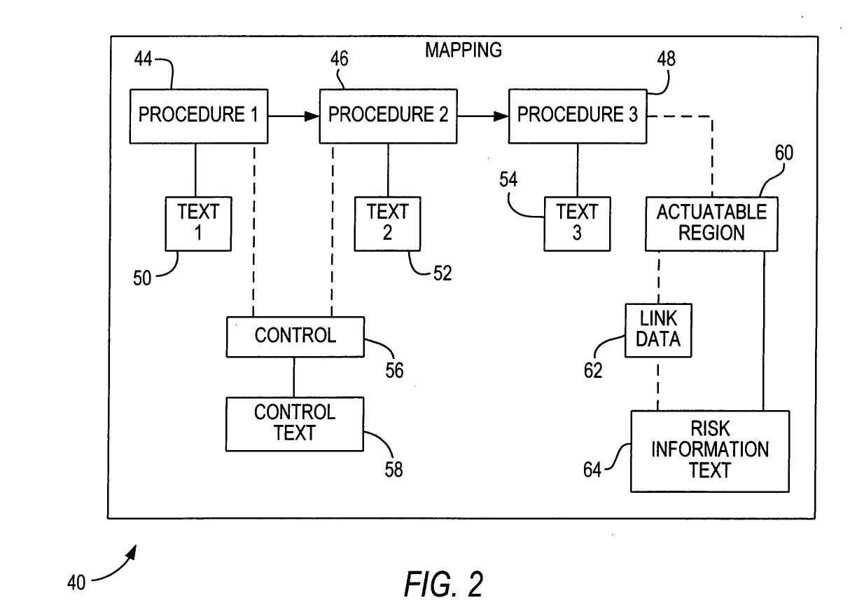

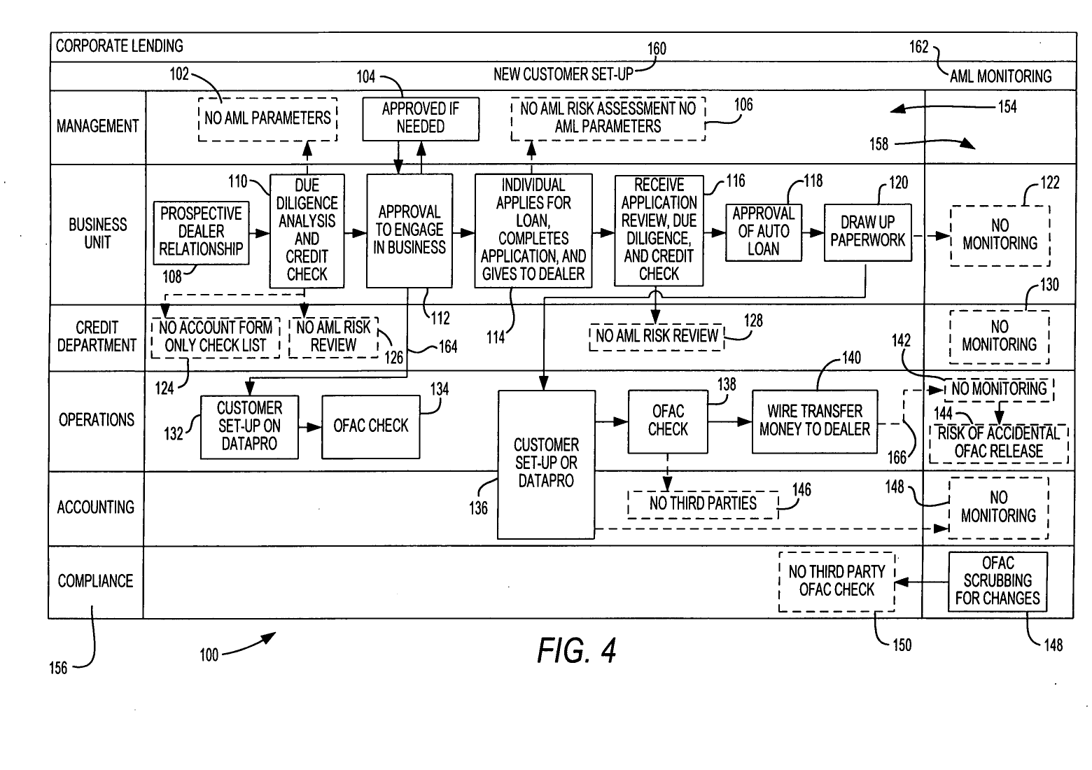

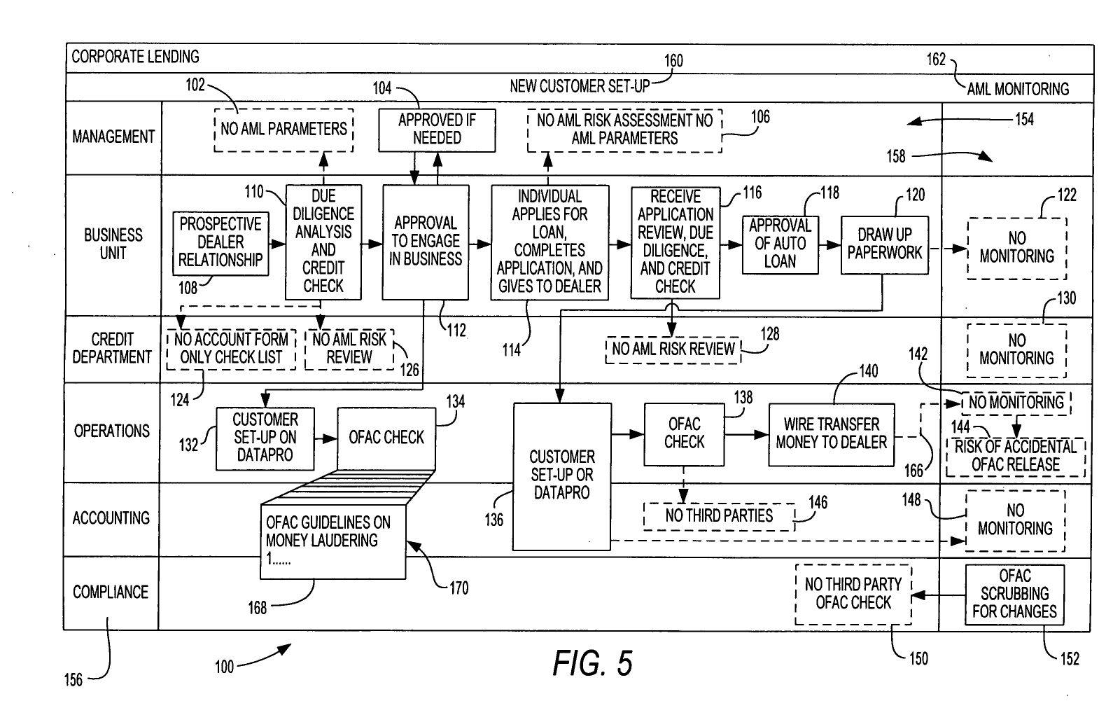

The processor 20 accesses the memory 22 to retrieve the map data 24 for displaying a mapping 40 on the browser 18, generally shown in FIG. 2 and as shown with the example mapping 100 in FIGS. 4-5. The memory 22 also stores risk information associated with specific processes which the processor 20 may access and display to the user navigating the displayed mapping 100. The memory 22 also includes link data 42, for example, corresponding to hyperlinks allowing the user to select and actuate an actuatable display region on the browser, such as icons or hot spots, to access additional information, such as the risk information 26 associated with a process corresponding to the selected actuatable display region.

Referring to FIG. 2, the mapping 40 includes the plurality of processes, such as procedures 44-48 to be followed in a predetermined sequence. Each procedure 44-48 includes an associated text 50-54, respectively, which may also include other information, such as graphics, audio and/or video describing or otherwise illustrating the respective procedure 44-48. The text of each procedure may also be a label displayed in the mapping through the browser 18, as shown in the blocks 102-152 representing processes in FIGS. 4-5. Other processes may include a control 56 with associated text 58 describing or labeling the control, with the control 56 being associated with a specific process associated with at least one other process, such as the procedures 44-46. For example, the control 56 may be a graphic and/or audible warning signal or red flag to the user when an associated process, such as procedure 44, is being accessed by the user.

The mapping 40 also includes actuatable regions 60 such as icons which are displayed with the corresponding text 54 for the procedures 48 associated with the actuatable region 60 in the displayed mapping 40 viewable through the browser 18. The actuatable region 60 is associated with predetermined link data 62, and stored in a set of link data 42 in memory 22, so that actuation of the actuatable region 60 causes the processor 20 to utilize the predetermined link data 62 as an address or hyperlink to retrieve the specific risk information text 64 associated with the predetermined link data 62, which is in turn associated with the actuatable region 60 corresponding to a specific procedure 48 being accessed by the user for additional information.

As used herein, the term “hyperlink” means any type of link, such as an Internet link, to another webpage, document, or other information in any format, and also to link to another part of the program or to other programs and/or databases accessed via the user's intranet. Specific examples and methods are described below.

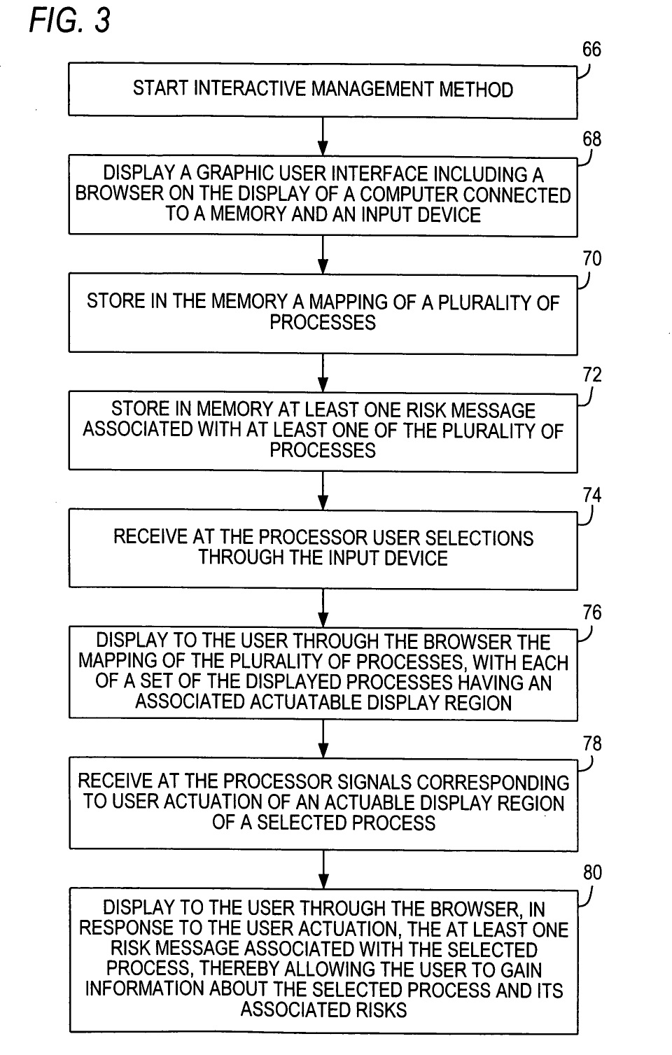

As shown in FIG. 3, in operation, the interactive management system 10 starts in step 66 the interactive management method, and displays in step 68 a graphic user interface including the browser 18 on the display monitor or other screen 16 of the computer 12 connected to the memory 22 and the input device 14. The memory 22 stores in step 70 the mapping 40 of a plurality of processes, and stores in step 72 at least one risk message or information 26 associated with at least one of the plurality of processes. The processor 20 receives in step 74 user selections through the input device 14, and displays in step 76 to the user through the browser 18 the mapping 40 of the plurality of processes, with each of a set of the displayed processes having an associated actuatable display region 60.

The processor 20 receives in step 78 signals corresponding to user actuation of an actuatable display region 60 of a selected process, and the processor 20 causes the display 16 to display in step 80 to the user through the browser 18, in response to the user actuation, the at least one risk message or information 64 associated with the selected process, such as procedure 48, thereby allowing the user to gain information about the selected process and its associated risks.

In an example embodiment, the computer 12 may be a laptop, a personal computer, or terminal connected to a network or other external devices 28, such as the Internet 30 or a dedicated intranet 32 associated with the organization of the user, such as the bank for which a loan officer processes new loan applications.

The processor 20 is responsive to user selections through the input device 14 to display to the user, through the browser 18, the mapping 40 of the plurality of processes, with each of a set of the displayed processes having an associated actuatable display region 60. The processor 20 is also responsive to user actuation of the actuatable display region 60 of a selected process, and displays to the user through the browser 18 the at least one risk message or information 64 associated with the selected process.

The memory 22 is accessible through a computer network, so that any user using a browser 18, communicating through the computer network, may access and view the mapping 40 and may actuate the actuatable display regions 60 to selectively view the at least one risk message or information 64. The memory 22 may be a separate file server upon which the mapping 40 and other process data are stored. Alternatively or in addition, the memory 22 may be a removable storage medium such as a compact disk (CD) which may be updated regularly to reflect changes in the policies, processes and procedures of an organization. Accordingly, the interactive management system 10 and method may operate without local databases, but instead may be used in the field or used independently of the intranet 32 or internal computer network of the organization.

The computer 12 may communicate through the external devices 28, for example, to hyperlink to retrieve additional information as the user views processes in the mapping 40. In order to perform this information retrieval, actuatable display regions 60 are associated with the link data 62 addressing linkable data stored in the memory 22. The processor 20 responds to the actuation of a selective actuatable display region 60 to communicate with the memory 22 via the predetermined link data 62 to retrieve the corresponding linkable data.

The link data 42, 62 may be a hyperlink, such as a uniform resource locator (URL) or other types of addresses, or file or directory names, for accessing data stored in the memory 22 and/or in the external devices 28 in communication with the computer 12.

The processor 20 operates mapping software 38 to display the mapping 40 and the plurality of processes as graphical representations on the display 16, for example, in a multi-dimensional format and/or with color representations indicating types of processes, available information, warnings, and the like. The mapping software 38 displays subsets of the plurality of processes in a plurality of horizontal tracks or lanes, with the horizontal tracks oriented one above the other vertically. In one preferred embodiment, the mapping software 38 is the graphics software available from “MICROSOFT CORPORATION” under the trademark “MICROSOFT VISIO”.

The interactive risk management system 10 and method described herein provides a new comprehensive solution for effective Enterprise Reputation Risk management, which requires a comprehensive methodology and implementation platform. Organizations, for example, in the financial services industry, may use the interactive risk management system 10 and method for identifying and reducing reputation risk, with a comprehensive analysis methodology which enables management to effectively identify, mitigate and control reputation risk for all products and services and all departments of the organization on an ongoing basis.

In performing the comprehensive Enterprise Reputation Risk analysis, solutions and controls, the interactive risk management system 10 and method may be used as a very cost-effective non-database solution with little or no information technology (IT) intervention or support required. In addition, the interactive risk management system 10 and method may be specifically designed to supplement and complement existing Basel II and business processing management (BPM) methodologies known in the art. The mapping of processes may be created with rapid turnaround, for example, average projects may be completed in about 120 days or even less.

As will be apparent to one of ordinary skill in the art, the timetable depends upon the availability of the organizations personnel for interviews with those preparing the mapping and the number of programmers applied to the project.

One advantage of the interactive risk management system 10 and method of the invention is the ability to facilitate effective monitoring, control and rightsizing of processes and risks in an organization, and provide a modern host environment for policies and procedures. For example, constant and consistent updating and version control may be assured throughout the organization.

For effective operation of the entire organization, the interactive risk management system 10 and method are excellent for controlling and monitoring branch offices and cross-border products, and are useful tools for planning and implementing control environments for new products, processes, systems and procedures. By implementing a readily-accessible mapping of processes, the interactive risk management system and method of the invention serves as an “organizational memory” and provides a permanent record regarding processes and controls.

The interactive risk management system 10 and method enable an organization to identify, control, and monitor Enterprise Reputation Risk and a series of carefully planned, interrelated elements are included. For example, effective reputation risk detection begins with two requirements: independence and experience. It may be very difficult to “cut through” the fabric of organizations in a totally objective manner. It requires skill and experience to know where to look, the areas to probe and the issues to analyze. It requires independence to ask difficult questions and to glean information from disparate, but interrelated parts of an organization.

Moreover, specialized experience is required to know how to analyze seamlessly between front and back offices and through all product and support areas from a variety of risk areas, in order to analyze and produce a mapping of the processes of an organization.

The interactive risk management system 10 and method analyze and allow for the monitoring of three key areas of risk: business or inherent risk, regulatory risk, and operational risk.

Both the definitions of these key risk areas and their sub-risk components vary among financial services industries and even within common industries. In one perspective, the organization sets common definitions and risk factors so as to ensure that the analysis and mapping are consistent with the organizational environment and culture of the organization. Moreover, this element facilitates a dialogue between the creators of the mapping and management regarding alternative risk definitions and factors which may be common in the industry, but not fully developed or identified within a given organization.

Referring to FIGS. 3-5, in order to create the map of processes, interrelationships between processes may be determined and incorporated into the mapping 40. For example, one type of interrelationship is a control 56 of one process by another process. To be effective, a control 56 must be rationally connected to a particular process, must be specifically designed to mitigate the risks which exist at that point in the process and must be capable of measurement.

The interactive risk management system 10 and method, in a preferred embodiment, display the process mapping 40 using highly visible, colorful, three-dimensional maps, for example, in the “MICROSOFT VISIO” format, designed to simultaneously display horizontal or cross-organizational processes, and vertical or drill-down processes. Once the maps are completed, they present a unique, three-dimensional “as is” picture of the organization's processes from a risk standpoint.

As shown in the illustrative screen shots in FIGS. 4-5, the interactively displayed mappings 40 may be displayed on a browser 18 in the form of labeled blocks corresponding to predetermined processes showing their interrelationships. In the example mapping 100 shown in FIG. 4, a bank's loan officer may view the mapping 100 for performing corporate lending procedures. The mapping 100 includes a plurality of labeled blocks 102-152, each corresponding to a specific process or procedure for performing corporate lending, such as setting up new customers and monitoring anti-money laundering (AML) practices according to procedures and guidelines of the Office of Foreign Assets Control (OFAC) established by the U.S. Treasury.

Common types of processes performed are generally are laid out in sequence in at least one lane or track 154, with the processes in each lane being horizontally displayed with appropriate labels 158 on each lane. In addition, common cross-type activities are grouped in vertical columns 156, such as new customer set-up and AML monitoring, with appropriate labels 160, 162 for each vertical column.

For example, in a management track, a “No AML Parameters” process 102, an “Approval if Needed” process 104, and a “No AML Risk Assessment, No AML Parameters” process 106 are displayed. In a business unit track, a “Prospective Dealer Relationship” process 108, a “Due Diligence Analysis, and Credit Check” process 110, an “Approval to Engage in Business” process 112, an “Individual Applies for Loan, Completes Application, and Gives to Dealer” process 114, a “Receive Application Review, Due Diligence, and Credit Check” process 116, an “Approval of Auto Loan” process 118, a “Draw Up Paperwork” process 120, and a “No Monitoring” process 122 are displayed. In a credit department track, a “No Account Form, Only Check List” process 124, a “No AML Risk Review” process 126, a “No AML Risk Review” process 128, and a “No Monitoring” process 130 are displayed.

In an operations track, a “Customer Set-up on DataPro” process 132, an “OFAC Check” process 134, a “Customer Set-up on DataPro” process 136, an “OFAC Check” process 138, a “Wire Transfer Money to Dealer” process 140, a “No Monitoring” process 142, and a “Risk of Accidental OFAC Release” process 144 are displayed.

In an accounting track, the “Customer Set-up on DataPro” process 136 is also displayed, along with a “No Third Parties” process 146, and a “No Monitoring” process 148. In a compliance track, a “No Third Party OFAC Check” process 150, and an “OFAC Scrubbing For Changes” process 152 are displayed.

The various processes may be connected by arrows 164, 166 illustrating the step-by-step flow from one process to the next. The solid arrows 164 may indicate a definitive process to be performed after the current process, such as a customer set-up 132 being performed after approval to engage in business 112. Other types of arrows, such as dashed arrows 166, may show optional branching or decisions based on completion of a current process. For example, after a wire transfer 140 is performed, the organization may flag the wire transfer for “no monitoring” 142. The risk of accidental OFAC release 144 of personal information may also be viewed by the loan officer.

Predetermined processes such as processes 108-120 may be illustrated with blocks having solid lines, while such optional processes 102-106, 122-130, and 142-150 may be displayed with blocks having dotted lines. As an alternative to, or in addition to, rectangular blocks, color coding, solid arrows, solid lines, dotted arrows, and dotted lines may be shown in the mapping 100, and the interactive management system 10 and method may display the mapping using different colors, different shading of the arrows and/or blocks, and different shapes for the blocks, such as red borders for very important processes to be performed. Other types of graphics such as stop signs may be used.

Using the mappings of FIG. 4, a user such as a loan officer may access and view addition information. For example, one or more of the processes or procedures 102-154 may have an associated actuatable region as described above in conjunction with FIG. 2, so that actuation of a selected process by clicking a mouse button or equivalent device, when the mouse cursor overlaps the selected process, causes the processor to access the corresponding link data to access and retrieve associated risk information text associated with the selected process.

For example, referring to FIGS. 4-5, when the user selects the “OFAC Check” process 134 in FIG. 4, the associated link generates a pop-up information box 168, as shown in FIG. 5, to display to the user the organization's policy for risk management involving an OFAC checking procedure. The information box 168 may include display controls 170 such as a slidable icon to scroll through a page of the information on the displayed topic.

It is to be noted that, although the information box 168 overlaps the Accounting and Compliance tracks, the pop-up information box 168 is not a separate process in the track, but is only displayed on the mapping 100 temporarily and is associated with the actuated process 134.

Through the mapping 100 shown in FIGS. 4-5, with additional accessible information such as the information box 168, the interactive risk management system and method permit a user to perform a Risk Diagnostic Analysis and Solution Mapping function to bring together multiple aspects of process management, for example, process operation, risk identification, and a solution meeting the needs of the user. The interactive risk management system and method of the invention act as effective tools for risk and solution analysis. During creation of the process mapping, business, regulatory, and operational risks which exist at each process step are identified and connected, and practical and effective solutions as well as controls are established which mitigate the identified risks. The risk analysis and proposed control solutions are embedded in the three-dimensional mapping so that, in a very short time, management and staff are presented, by the interactive risk management system 10 and method and their map and data presentation format, both their verified process flows as well as an analysis of identified risks and solutions. These mappings are easy to understand and lead to important and practical explanations of ways to mitigate risk.

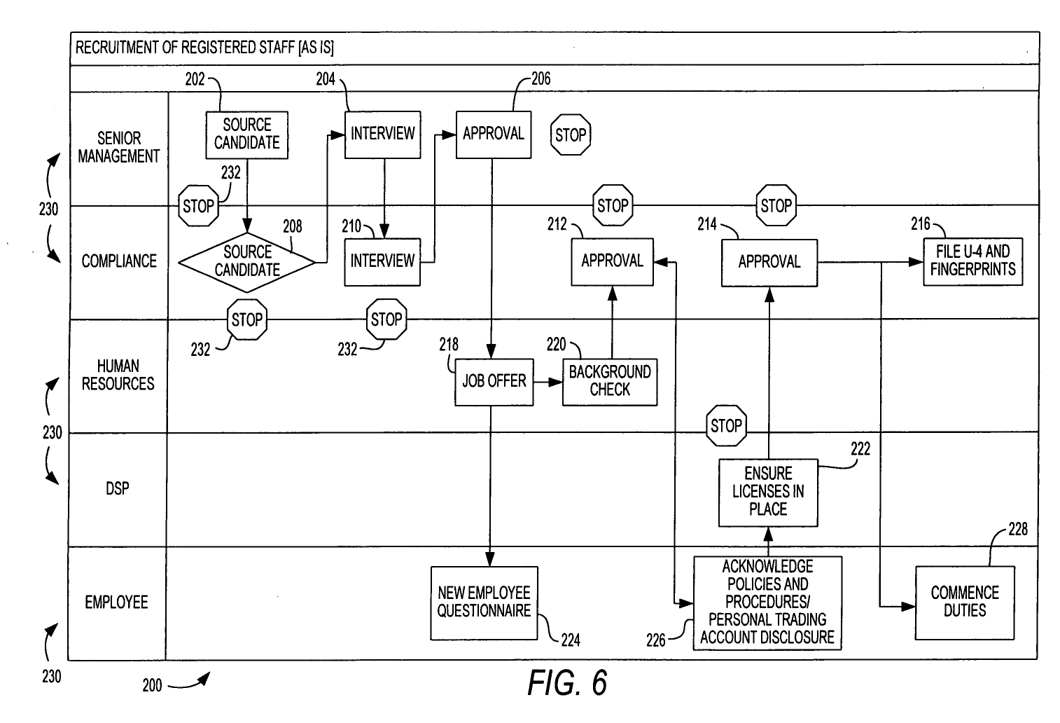

In an alternative embodiment, shown in FIGS. 6-8, the interactive risk management system and method may make use of indicators and/or other indicia or images, such as displayed stop signs, to indicate to the user that the process displayed substantially adjacent to the stop sign has an associated risk.

For example, FIG. 6 illustrates a display screen displaying the alternative embodiment of a mapping 200, in which a plurality of processes 202-228 are organized into a plurality of tracks 230, for example, to map and illustrate to the user the procedures employed by an organization in the recruitment of registered staff. As described in connection with FIGS. 4-5 and the mapping 100, the processes 202-228 of the mapping 200 may include actuatable regions which, upon activation by the user, provide additional information about the associated process selected by the user to access and review the information.

Specific processes, such as the processes 202, 206, 208 and 210, may have associated risks for which additional information is available. Accordingly, the interactive risk management system and method flags such processes or otherwise alerts the user of possible risks using visual and/or audible signs and/or signals, such as the image of stop signs 232. Alternatively or additionally, other visual cues such as the use of different colors for the stop signs 232 that contrast with the color of the process blocks 202-228 and/or flashing colors of the stop signs 232 or of the process blocks 202-228 may also be used to visually notify the user of additional information, for example, of a risk associated with a given process.

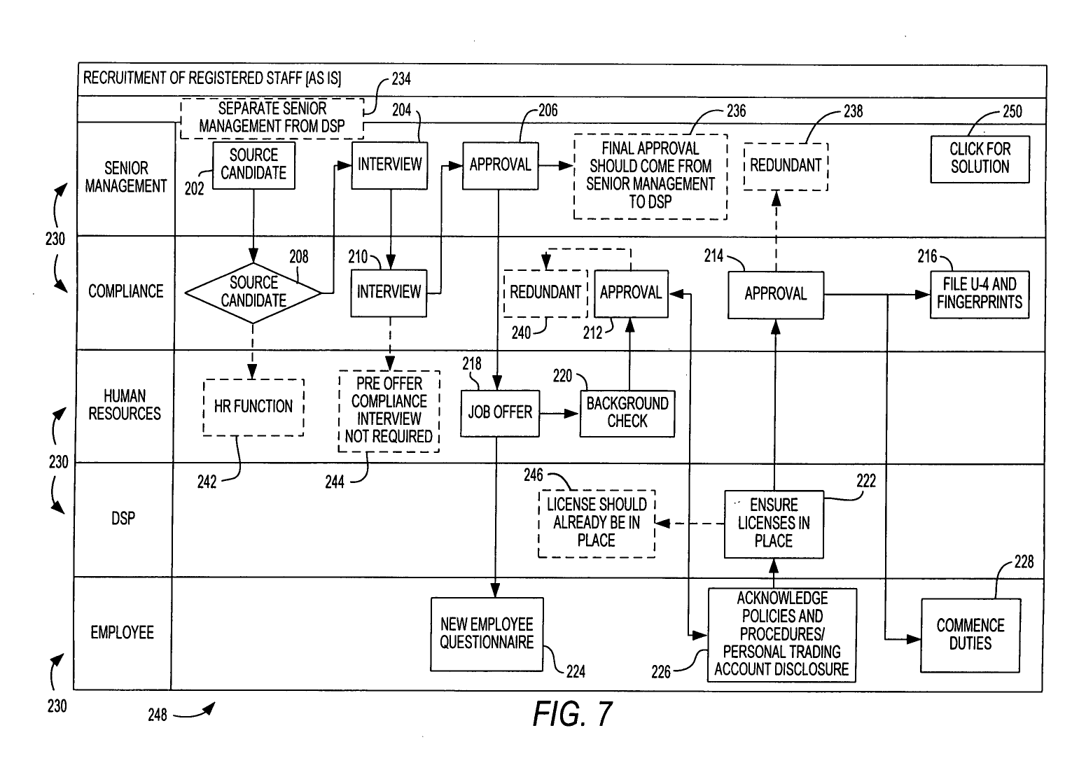

Such stop signs 232 may also be actuatable regions, so that actuation of a stop sign causes the mapping 200 to display one or more risk information blocks 234-246 in a modified mapping 248, as illustrated in FIG. 7. The risk information blocks 234-246 may be displayed in one or more of the tracks 230 only for illustrative purposes, so that the risk information blocks 234-246 are positioned substantially adjacent to their respective processes 202-228.

The risk information blocks 234-246 may have visual indicators such as dashed lines instead of the solid lines of the process blocks 202-228, as shown in FIG. 7, or colored blocks which contrast the colors of the process blocks 202-228. The user is thereby provided with visual cues to indicate that the risk information blocks 234-246 are separate and distinct from the process blocks 202-228.

In addition, the risk information blocks 234-246 may also be actuatable regions through which the user may access additional information, that is, actuation of one of the risk information blocks 234-246 causes the interactive risk management system 10 and method to retrieve and access additional and/or explanatory risk information.

As described herein and shown in FIGS. 4-7, the mappings 100, 200 may reflect an existing structure of an organization. The interactive risk management system 10 and method may also be used to display to the user a proposed solution to the existing structure to minimize or eliminate risks associated with the various processes.

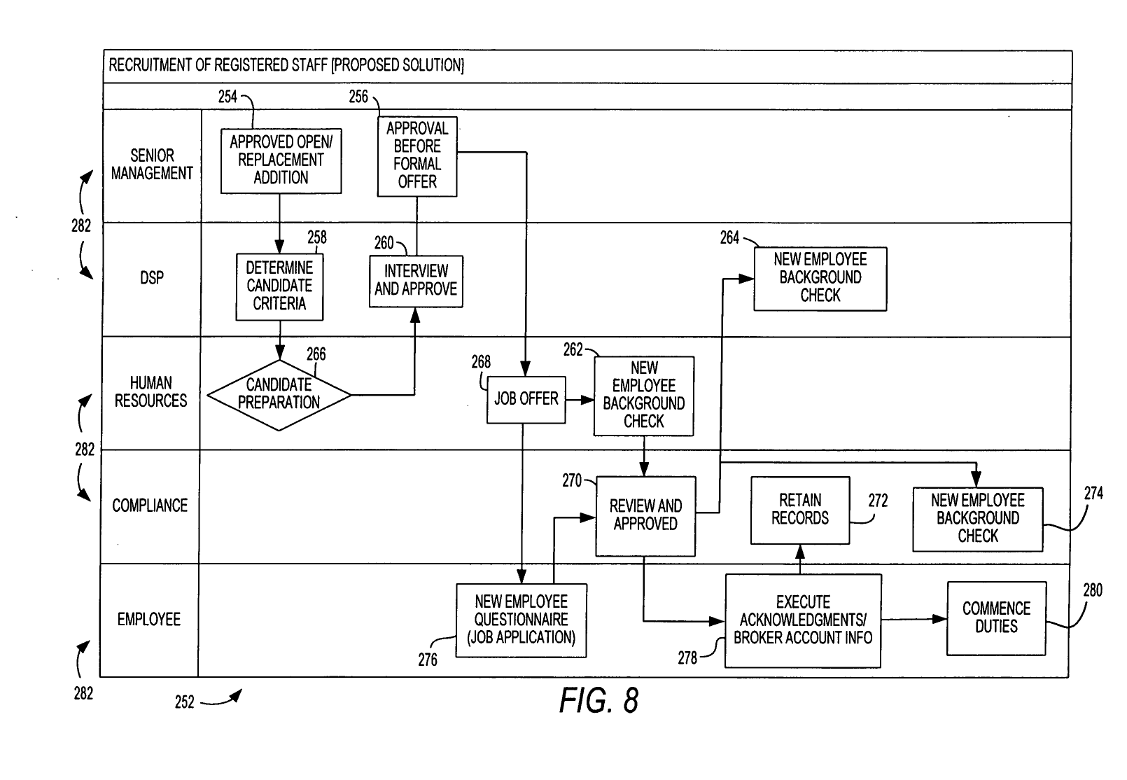

For example, the mapping 248 of FIG. 7 displays the associated risks in risk information blocks 234-246 of the processes illustrated in the original mapping 200 in FIG. 6. On the mapping 248, an actuatable region or icon 250 may be provided to access a solution mapping, as shown in FIG. 8. Note that the position of the solution icon 250 is arbitrary, that is, the positioning of the solution icon near a process, such as the process 216, or in a track 230, does not indicate that the solution mapping is only associated with the nearby process 216 or track 230.

FIG. 8 illustrates a display screen displaying another modification of the mapping of FIGS. 6-7. The mapping 252 in FIG. 8 illustrates a solution mapping which minimizes or eliminates the risks described in the risk information blocks 234-246 of FIG. 7. The solution mapping 252 has a plurality of processes 254-280 organized in at least one track or lane 282, which provides a proposed or final solution to the user in the form of a revision to the organization in a manner that minimizes or eliminates the risks, for example, in the recruitment of registered staff.

As shown in FIG. 8, and in comparison to FIGS. 6-7, the solution mapping 252 may have processes 254-280 which are different from the original processes 202-228 of the organization, and such processes 254-280 may be organized in tracks 282 or lanes different from the tracks 230 in FIGS. 6-7. Some or all of the processes 254-280 may be common to the processes 202-228, such as the “Interview” processes 218, 268 and the “Commence Duties” processes 228, 280, and similarly some or all of the tracks 282 may be common to the tracks 230, such as an “Employee” track or lane and an “HR” or “Human Resources” track or lane.

However, despite any common processes or tracks, the solution mapping 252 is distinct from the original mapping 200 in that the processes 202-228 are re-arranged, modified, and/or deleted, and new processes may be added to present a proposed solution that minimizes or eliminates the risks in the overall organization.

Accordingly, an initial mapping may be prepared, and once management reviews and agrees on risk-mitigating solutions, the initial mapping may be revised to re-map the process flows to reflect the new control environment. The new maps reflect actual process flows and/or solutions with control points duly noted. Policies, procedures, forms, and information sources, as well as web-links, may be amended to conform to the new controls and may be hyperlinked directly to process steps on the maps. Using the interactive risk management system 10 and method, staff members may access and know exactly what steps to follow at each process point to mitigate risk.

In addition to viewable process steps, “control boxes” are viewable and accessible within the flow for process monitoring on an ongoing basis. For organizations which have implemented BPM, the interactive risk management system 10 and method is designed to work in conjunction with the metrics and controls which are being implemented.

The maps are available to all staff via their web browser, for example, through the organization's intranet 32. Each member of the staff has the ability, with a click of the mouse button, to access all processes within a given product, service or area from the highest level to the day-to-day work within a department. Control points are easily visible and applicable procedures and forms are only a click away from a given process step. The “control boxes” ensure that the process flow, which already conforms to the “as is” process of the organization, is followed and make monitoring easy to accomplish.

Once the basic structure of the organization, including its procedures and polices, is mapped by the interactive risk management system and method, third parties may verify and update the maps regularly or on an as-needed basis, and may make the maps available on a web-hosted basis.

### Additional Embodiments

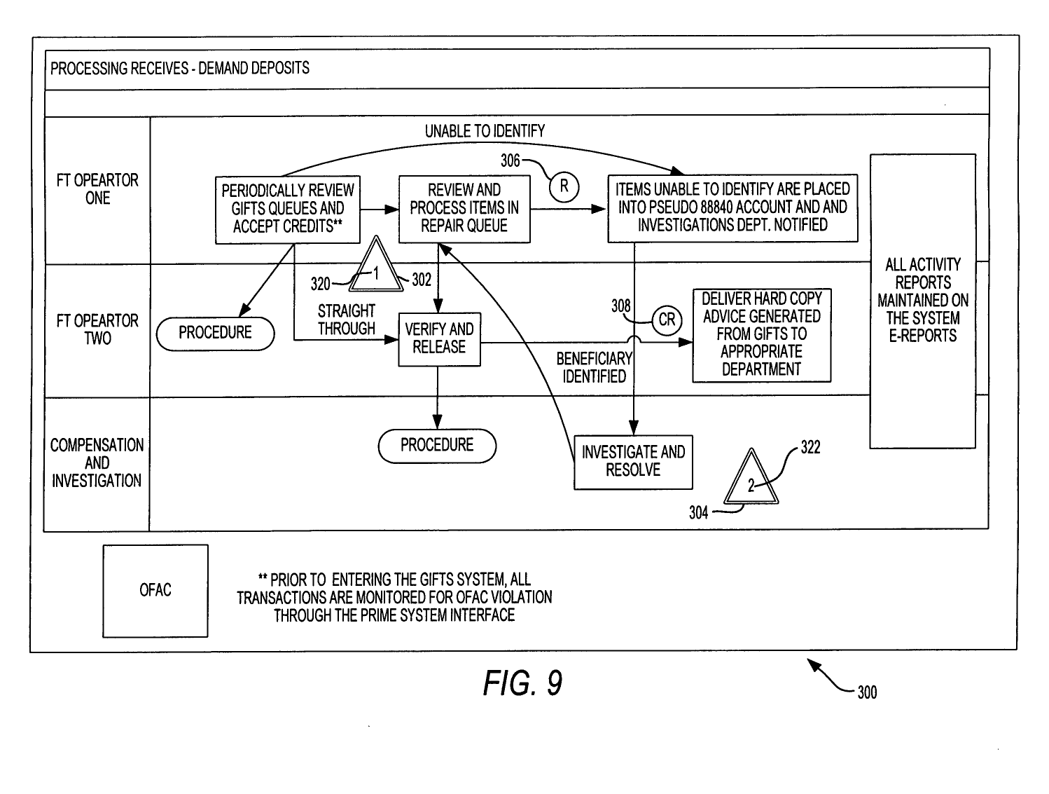

In additional embodiments shown in FIGS. 9-12, the interactive risk management system 10 and method may make use of indicators and/or other indicia or images in addition to and/or instead of stop signs to alert the user of the presence of additional risk analysis features within the displayed mappings, and so providing an enhanced mapping of the interactive risk management system and method.

In some embodiments of the present invention, significant control weaknesses are indicated in the mappings by stop sign images, which are linked and/or hyperlinked to an analysis page or other information, and optionally a proposed solution. To enhance the functionality of the mappings to be used as risk analysis and solution tools, the mappings may be expanded in additional embodiments to incorporate different and/or deeper analysis of the operational risks addressed by the interactive risk management system and method of the present invention.

FIG. 9 is a display screen 300 displaying the additional embodiment of the mappings, showing the use of yield sign indicators 302, 304 and the other indicators 306, 308 indicated by circles which embed and allow access to operational risk control reports within the mappings. Such indicators may include a displayed yield sign 302, 304, an “R” in a circle 306, and a “CR” in a circle 308, to indicate to the user that the processes displayed substantially adjacent to the displayed indicators have additional information. Such circles 306 displaying an “R” may be a green color or any other predetermined color, and the circles 308 displaying a “CR” may be green, amber, or red, or any other predetermined color, with such colors providing additional visual cues or indications to the user of the status of the process and any additional information associated with the process.

The stop sign image may continue to be used as shown in FIG. 6 to signify a significant control-related weakness requiring immediate management attention, while the yield signs 302, 304 signify an important control consideration or an enhancement to the risk control infrastructure of the entity or facility which is recommended.

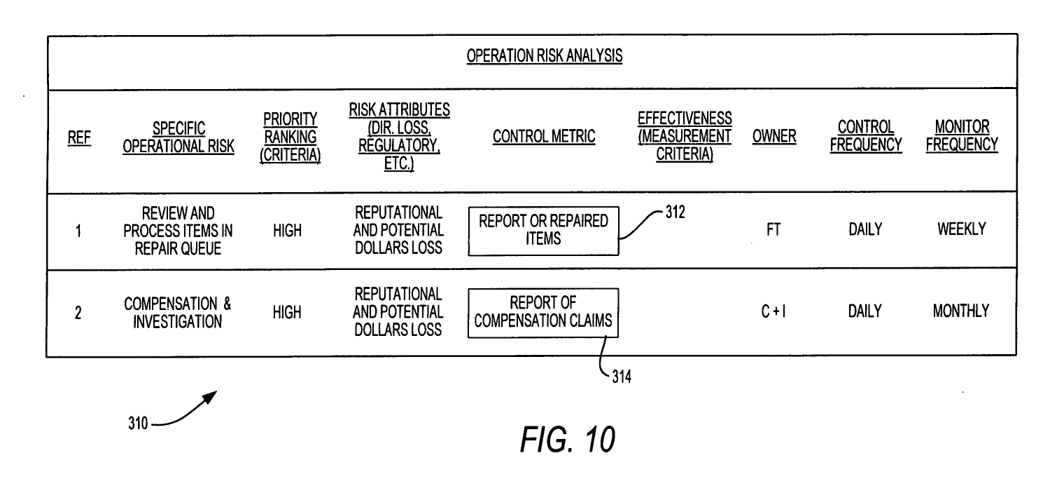

By accessing the yield signs 302, 304, for example, by clicking a mouse when the mouse cursor is over the selected yield sign, a display screen 310 as shown in FIG. 10 is generated for displaying a list of accessible control reports, with corresponding GUI actuation regions 312, 314 with text such as “Report of Repaired Items” and “Report of Compensation Claims”respectively.

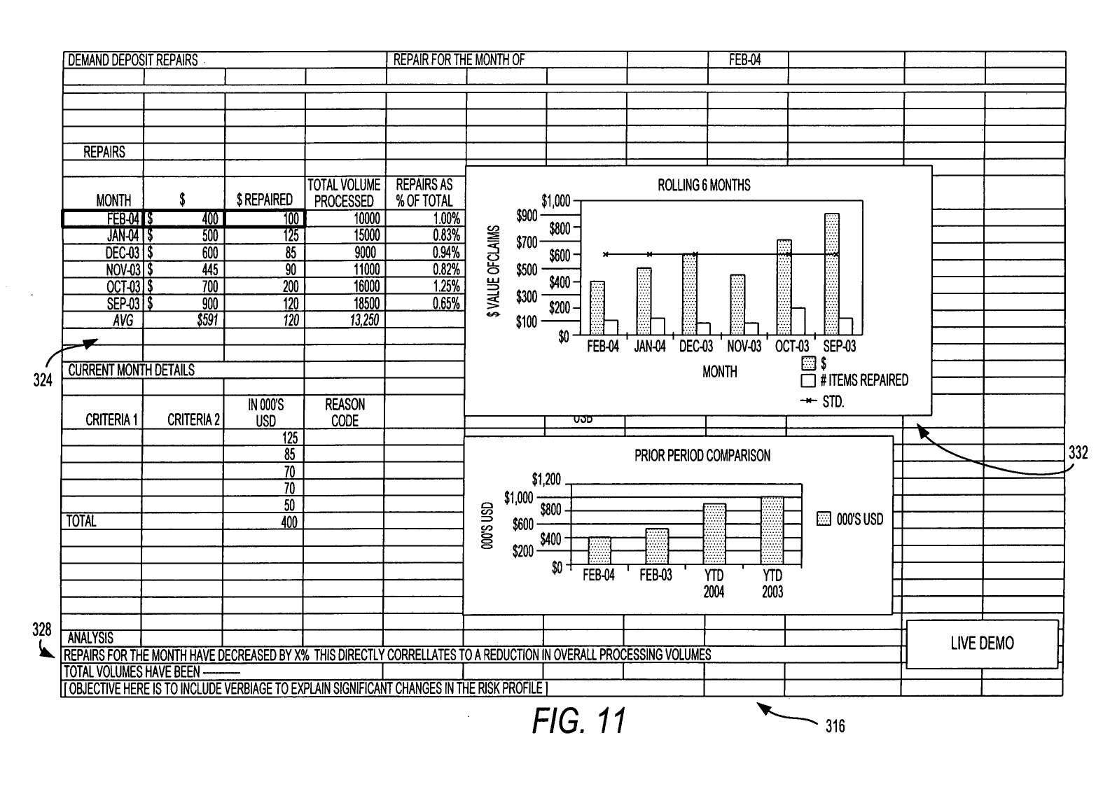

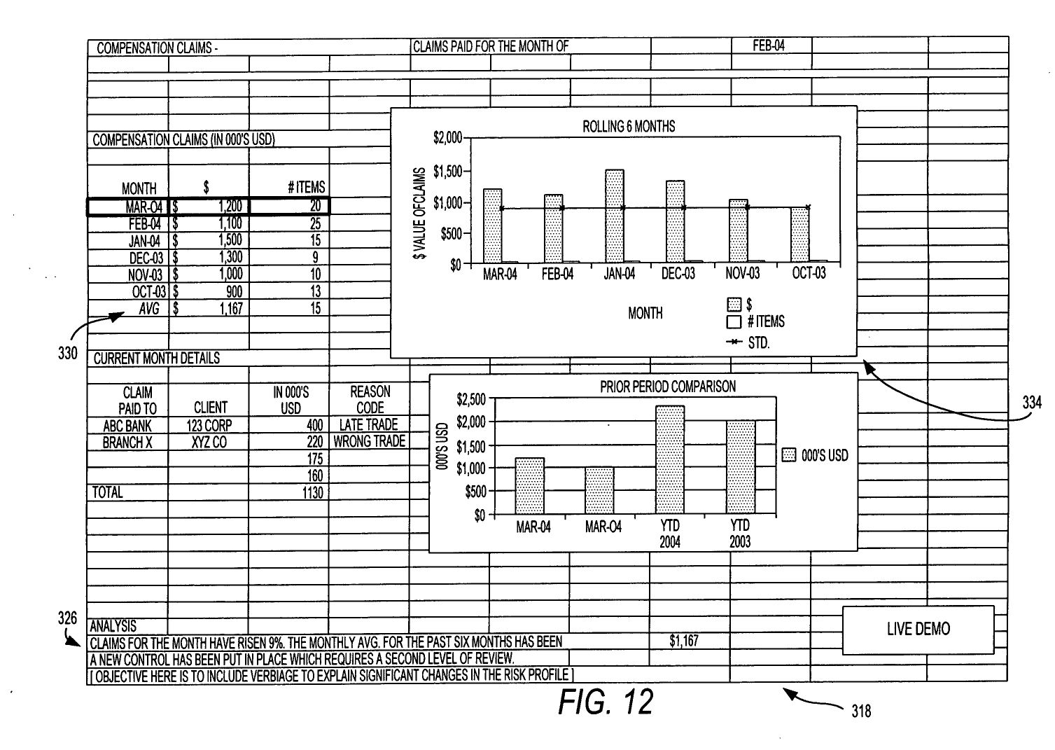

Information associated with the reports and corresponding actuation regions 312, 314 may include a reference number, a specific operational risk, a priority ranking, risk attributes, effectiveness values, a name or initials of an owner, a frequency of providing a control report, and a frequency of monitoring the process. Such accessible reports reflect operational risk analysis of the corresponding processes associated with the corresponding yield signs. The list 310 is accessed from the yield sign indicators 302, 304 in FIG. 9, with examples of such accessible reports, displayed via actuation of the regions 312, 314, shown in the display screens 316, 318 of FIGS. 11-12, respectively. Each report may be indexed by a reference number shown within the corresponding yield sign, such as the first report labeled by reference number “1” in the list 310 with a corresponding label 320 displayed in the first yield sign, and the second report labeled by reference number “2” in the list 310 with a corresponding label 322 displayed the second yield sign.

FIG. 11 is a display screen 316 displaying a first report corresponding to the first yield sign 302 which reports repaired items over various periods of time. FIG. 12 is a display screen displaying a second report corresponding to the second yield sign which reports compensation claims over various periods of time. Such reports may include a spreadsheet, such as a “MICROSOFT” “EXCEL” spreadsheet, or a report, image, and/or printout generated by such spreadsheets or other software, such as “MICROSOFT” “WORD” word-processing software, “MICROSOFT” “ACCESS” database software, or “ADOBE” “ACROBAT” image software. As shown in FIGS. 11-12, the reports may include data 324-326, text 328-330, and/or graphics or images 332-334, such as charts including bar charts.

Regarding the other types of indicators, in an example embodiment, the “R” in the green circle 306 in FIG. 9 may be actuated by clicking the mouse when the mouse cursor is over the green circle 306, and such actuation causes the display of a management report produced in the normal course of business. In the example embodiment, the “CR” in a colored circle 308, as shown in FIG. 9, provides access, for example, by mouse actuation, to control reports specifically developed to control a certain defined element of operation risk. A “CR” in a green circle indicates the availability of a report which has been produced but with no specific risks or considerations to be acted on. “CR” in an amber circle indicates an enhancement or recommendation to a control report which management should consider. A “CR” in a red circle indicates either the lack of a control report at a critical risk junction or a significant enhancement which is required in an existing control report in order to make the control report effective to measure the identified risk. Alternatively, instead of letters, number, symbols, and combinations of letters, numbers, and/or symbols may be displayed in the circles.

Other letters or symbols in circles or other geometric shapes, as well as other predetermined colors shading such geometric shapes, may be used to indicate the type and/or nature of the corresponding reports, and to provide corresponding reports upon GUI actuation, according to a predetermined report indicator scheme, such as the stop and yield signs and colored and labeled circles described herein.

In the case of control reports, the user of the interactive risk management system and method, with such mappings and visual indicators, has the ability to link and/or hyperlink from the indicators, such as a report circle, to an analysis page in which a chart sets forth salient details about the report, such as the name of the report; its purpose, for example, in terms of the risk being controlled; to whom the report is circulated; the frequency of production of such reports; and indicators of who is responsible for monitoring such risks. The interactive risk management system and method may also hyperlink to a copy of the relevant report itself.

### Further Embodiments

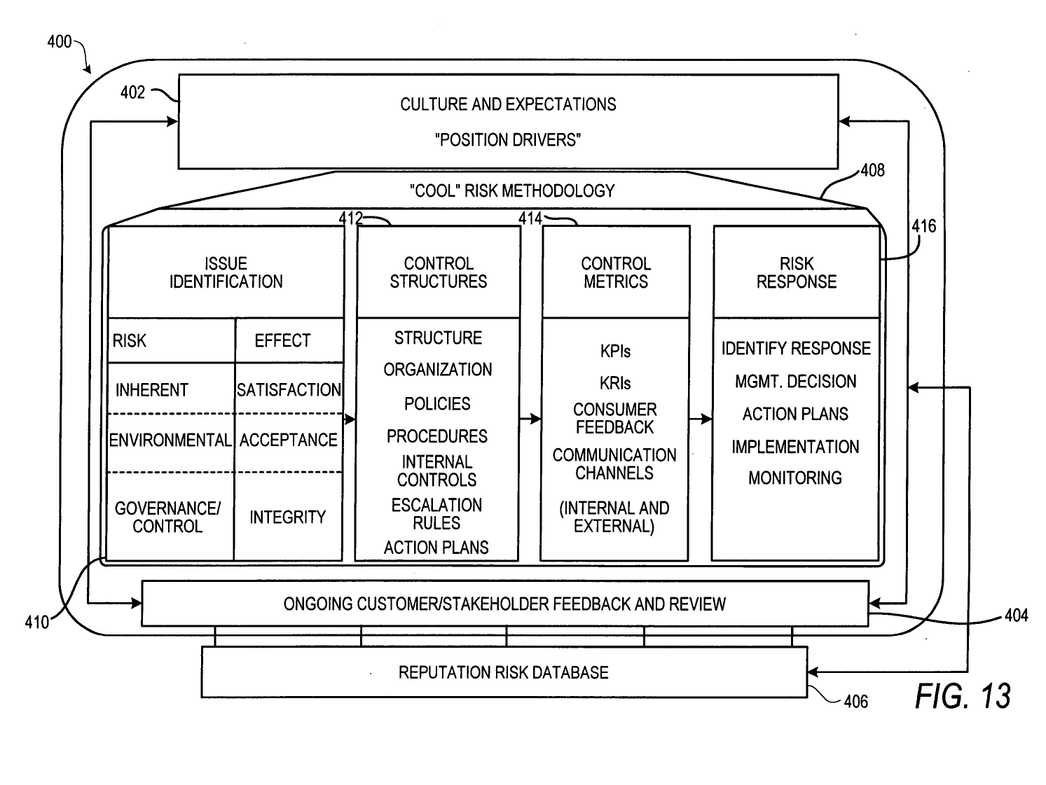

In further embodiments shown in FIGS. 13-17, the interactive risk management system 10 and method may also perform reputation risk management analysis, using the processor 20 and other components described herein, to process the risk messages and other risk information and data to generate and display impact level data, such as the likelihood of a predetermined impact criteria, to affect the reputation of an entity such as an institution. Accordingly, reputation risk reduction may be readily and effectively performed. The implementation of the interactive risk management system 10 and method for identifying, measuring, monitoring, and managing the reputation risk reduction is commercially available as “R3” from “IMAG, INC.”; and may be used in combination with the risk analysis tools and techniques described herein and commercially available as “COOL” from “IMAG, INC.” The interactive risk management system 10 and method allow risk to be managed and reduced not only at the senior management level but also by staff at all levels, for example, by staff having specific assigned duties and responsibilities for various issues affecting the reputation of the entity such as a company, includes issues pertaining to environmental concerns, lawsuits, etc.

A general overview of the reputation risk management system and method, implemented by the disclosed interactive risk management system 10 and method, is shown and described herein with reference to FIGS. 13-17. Using the reputation risk management system and method described herein, issue identification, impact measurement, and risk reduction are performed to manage the reputation risk of an entity. Issue identification may include uncovering and identifying key risk issues and potential reputation risk events across the products, services, and operations of an organization. Impact measurement is performed as well since not every risk issue gives rise to reputation risk, and so a risk assessment methodology is utilized to isolate those issues which are most capable of having an impact and giving rise to reputation risk events. Risk reduction is performed by implementing appropriate risk responses and targeted solutions which must be implemented, or alternatively which should be or are highly recommended to be implemented, to control and mitigate potential reputation risk issues before such issues become public or to lessen and control the effects of reputation risk issues which have already been made public.

Issue identification may be developed through various information sources, such as interviews with key staff members; management information, reports, and data; internal management reviews; peer/competitive and industry information and data; legislative findings and government reports; consumer surveys and websites; rating agency findings; audit reports; best practice studies; and reviews of prior claims and potential litigation.

Such reputation risk management analysis may be performed manually with interactive inputs from users, and/or may be performed automatically by the processor 20 with predetermined data processing methods and algorithms, for example, using predetermined risk metrics such as mathematical formulae and/or logic programming known in the art and/or described herein to process data for different cases and circumstances using IF . . . THEN procedures and Boolean operators such as AND statements for determining a probability that a selected issue presents a high, medium or moderate, or low likelihood of risk to the reputation of an entity or institution.

FIG. 13 is a flowchart 400 of the operation of the system 10 for performing reputation risk management. Using data 402 reflecting culture and expectations for risk and reputation considerations, including position drivers, as well as data 404 storing ongoing customer and/or stakeholder feedback and review requested by the risk and reputation control facility of an entity, the present interactive risk management system 10 and method, commercially available as “COOL” from “IMAG, INC.”, processes the risk messages and other risk data and information using the processor 20 and predetermined software to generate reputation risk data values which are stored in a reputation risk database 406 used for implementing a predetermined risk methodology 408 to evaluate and respond to reputation risk of an institution.

The predetermined risk methodology 408 may be implemented by the processor 20 using known techniques for issue identification 410 such as risk, including inherent risks, environmental risks, and governance and control risks, as well as identification of the corresponding effects of such risks, including satisfaction, acceptance, and integrity. Inherent risk may include risks which arise from, or are an intrinsic feature of, products and services or their delivery, and which negatively impact market and customer satisfaction. Environmental risk may include risks which arise from the manner in which business is conducted, such as geographic, industrial, political, or societal issues affecting the manner of business conduct. While sometimes unrelated to the quality of the products or services, such environmental risks may negatively impact market and customer acceptance. Governance and control risk may include risks which arise from losses as a result of inadequate or failed internal processes, people, and systems as well as from losses caused by the failure of an organization to adopt or adhere to applicable laws, regulatory rules, codes, and industry standards or practices which negatively impacts the perception of the market and customers of institutional integrity. Such identified issues are then processed in connection with control structures 412, such as the overall structure, organization, policies, procedures, internal controls, escalation rules, and actions plans of the institution.

Control metrics 414 are then determined by the issues 410 processed with respect to the control structures 412, with the control metrics 414 which may include key performance indicators (KPIs), key risk indicators (KRIs), consumer feedback, and internal and external communication channels. Using the control metrics 414, the interactive risk management system 10 and method generates and outputs a risk response 416, which may include an identification of a response to be implemented by the institution to control or reduce the reputation risk, an identification of any management decisions for implementing the risk response, action plans generated to perform the risk response, events and characteristics of the implementation of the risk response, and monitoring of the risk response by the institution.

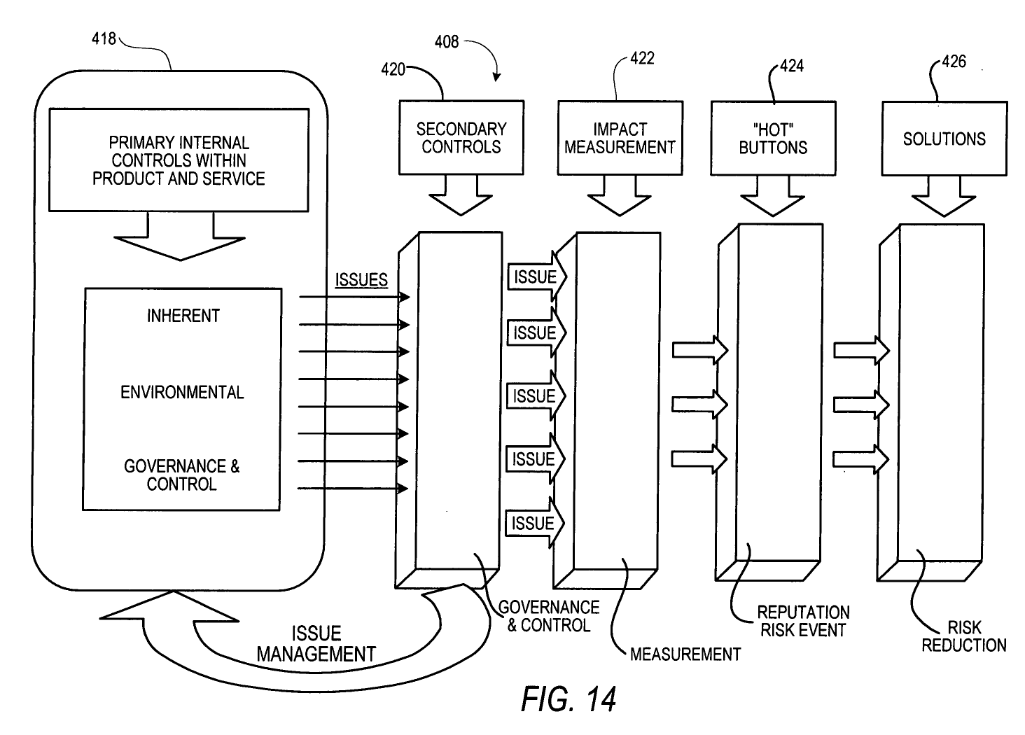

FIG. 14 is a flowchart of the methodology 408 in greater detail for performing the reputation risk identification and response process, by which primary controls 418 and secondary controls 420 and their related issues are processed by the processor 20 to determine respective impact measurements 422. Issue identification within the primary control area 419 and the secondary control area 420 uses product and service expertise provided by the entity such an organization, independent and experienced risk analysis, and a comprehensive risk identification and analysis methodology. The independence of the risk analysis is essential to ensure that the risk review is totally objective and free to focus on all product, service, and cross-organizational areas. Risk expertise is critical because of the complexity of the reputation risk area.

The primary controls 418 perform primary control issue identification by focusing upon three main areas of a product or a service area: objective setting and risk appetite, operational risk drivers, and regulatory risk drivers. The objective setting and risk appetite includes the established goals and objectives of a product or service area as well as the amount of risk an organization is willing to accept in the pursuit of value. Such evaluation of the objective setting and risk appetite involves an understanding of the culture and expectations; the susceptibility of a product or service to reputation risk; an understanding of the market and its players; an understanding of market patterns as well as business cycles and movements and trends and their effect on the product and service; an understanding of standards and best practices; and an ability to understand and respond to customer expectations.

Operational risk drivers are the operational factors affecting the product or service area. A sample of key risk drivers includes a lack of segregation of duties; a lack of effective internal controls; anecdotal and informal management; a lack of an agreed-upon methodology for identifying and controlling operational risk such as a lack of control metrics in place and utilized, a lack of KRI/KPI utilization, and a lack of flow-back of risk through a cycle such as servicing issues which arise out of origination practices; a reliance on people rather than on systems; a lack of comprehensive tacking of consumer feedback; ineffective and unfocused management information systems (MIS); high transaction volumes; complex support and technology systems; structural change as well as constant reorganization; varying skill levels of management and staff; outsourcing without oversight such as vendor, affiliate, and geographic considerations; and staff, budget, and resource constraints such as key people wearing “too many hats”, and systems initiatives not aligned with needs.

Regulatory risk drivers are the rules, laws, codes, regulations, etc. which affect the product or service area. Any issues affecting or transgressing such drivers may be included, such as money laundering; terrorist financing; suspicious activity reports (SARs) and OFAC issues; corporate governance issues such as the Sarbanes-Oxley law (SOX), and in particular Section 404 of the Sarbanes-Oxley law; the privacy and confidentiality of customer information; and consumer regulations on federal and state levels.

The secondary controls 420 are used for determining governance and internal control, and such secondary controls 420 provide a critical filter to capture and resolve issues which possibly are not captured within the product or service primary controls 418; are not resolved within the primary control environment; are outside of the scope of authority of a primary control area; involve transversal issues affecting multi-product lines; require group policy determinations or culture determinations; have a direct impact on a brand or franchise; involve sensitive or special topics; and/or require immediate senior intervention, such as part of an issue escalation.

The governance and internal control issues involve analysis factors in various areas including primary external factors; primary internal factors; organizational structure and/or culture; personnel policies and issues; compliance program information; internal audit program information; risk management program information; internal and dual controls; quality control; customer feedback utilization; peer management; issue escalation; communication, information, and coordination; and self-assessment and monitoring. The review of the primary and secondary controls surfaces key risk issues which are to be segmented in order to determine such risks which are capable of giving rise to reputation risk events.

After generating impact measurements as described herein, the impact measurements in turn are used to generate or identify various reputation risk events and hot buttons 424, such as the predetermined graphics 232, 302-308 described herein, for which risk reduction solutions 426 may be generated and displayed to the user through the display 16. Such impact measurements may also be stored in the reputation risk database 406 shown in FIG. 13.

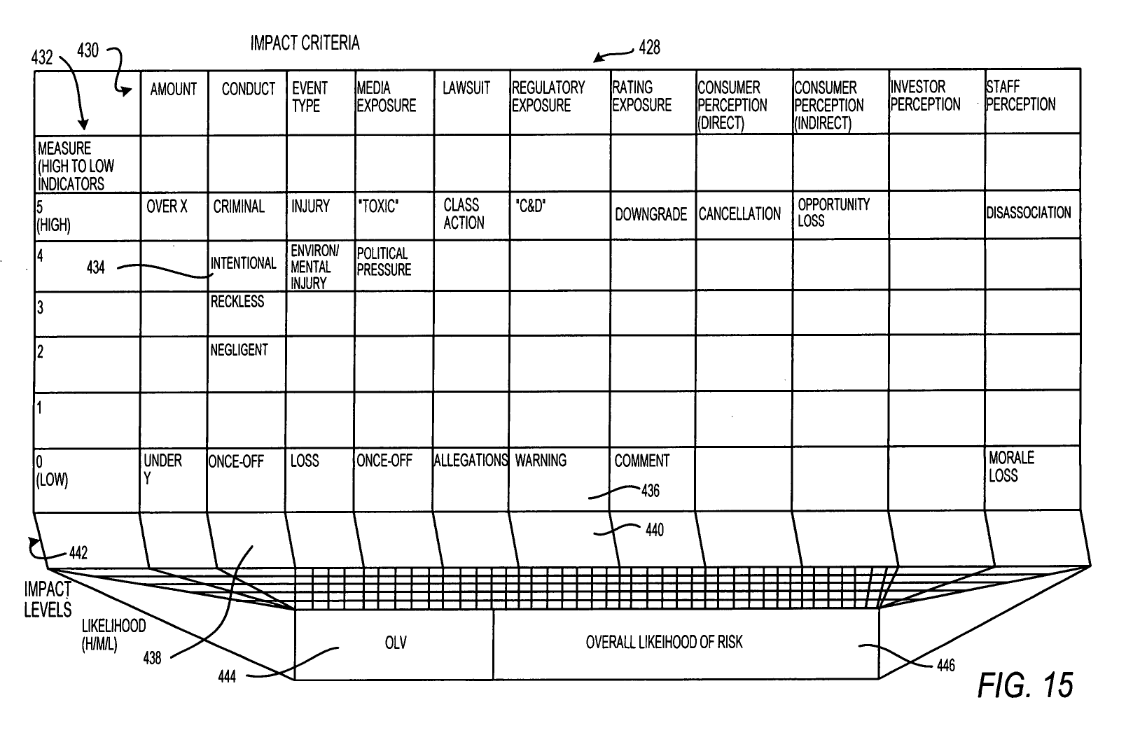

FIG. 15 is an impact measurement analysis matrix 428 by which the impact of risk is evaluated according to at least one issue listed in the row 430 with such issues reflected as impact criteria affecting risk to the reputation of an institution. The present interactive risk management system 10 and method, commercially available as “COOL” from “IMAG, INC.”, process the risk messages and information to generate reputation risk data values which may be manually and/or automatically entered into the impact measurement analysis matrix 428, or alternatively such entering of data may be performed interactively by the user using the input device 14. For example, the impact measurement analysis matrix 428 may be implemented by the processor 20 as a spreadsheet using “MICROSOFT” “EXCEL” commercially available from “MICROSOFT CORPORATION”, with risk being entered as numerical values and/or Boolean logic values, such as TRUE, FALSE, YES, or NO in the appropriate rows reflecting the impact levels for each impact criteria in the columns of the matrix. Such risk information may be automatically loaded into the spreadsheet from the reputation risk database 406 shown in FIG. 13.

By either automatic entry or manual entry, the impact measurement analysis matrix 428 may be displayed on the display 16 for interaction with a user for data input, review, and/or modification, such as a user override of a given risk factor; for example, to update the status of a lawsuit from allegations to a class action determination. The impact measurement analysis matrix 428 provides a reliable, user-friendly, predictive tool applicable to existing or new products and services of an entity, and applicable for isolating existing issues which have already been identified as real or potential crisis management issues. In addition, the impact measurement analysis matrix 428 segments the issues which may cause reputation risk, and may be adjusted to the particular requirements of an entity such as an institution or organization.

The interactive risk management system 10, using the processor 20, then uses predetermined metrics to generate a likelihood value or measure, corresponding to the measurement values in the column 432, as a probability value, such as a numerical value and/or a message such as HIGH, MEDIUM or MODERATE, and LOW, abbreviated as H, M, and L, respectively, reflecting the relative likelihood that, for a selected impact criteria or issue, the entity faces reputation risk. The likelihood value may be determined using fuzzy logic methods known in the art, or by predetermined formulae known in the art. For example, the likelihood value may be set to HIGH if the risk factor has a measure between 4 and 5, inclusive; the likelihood value may be set to MEDIUM if the risk factor has a measure between 2 and 3, inclusive; and the likelihood value may be set to LOW if the risk factor has a measure between 0 and 1, inclusive.

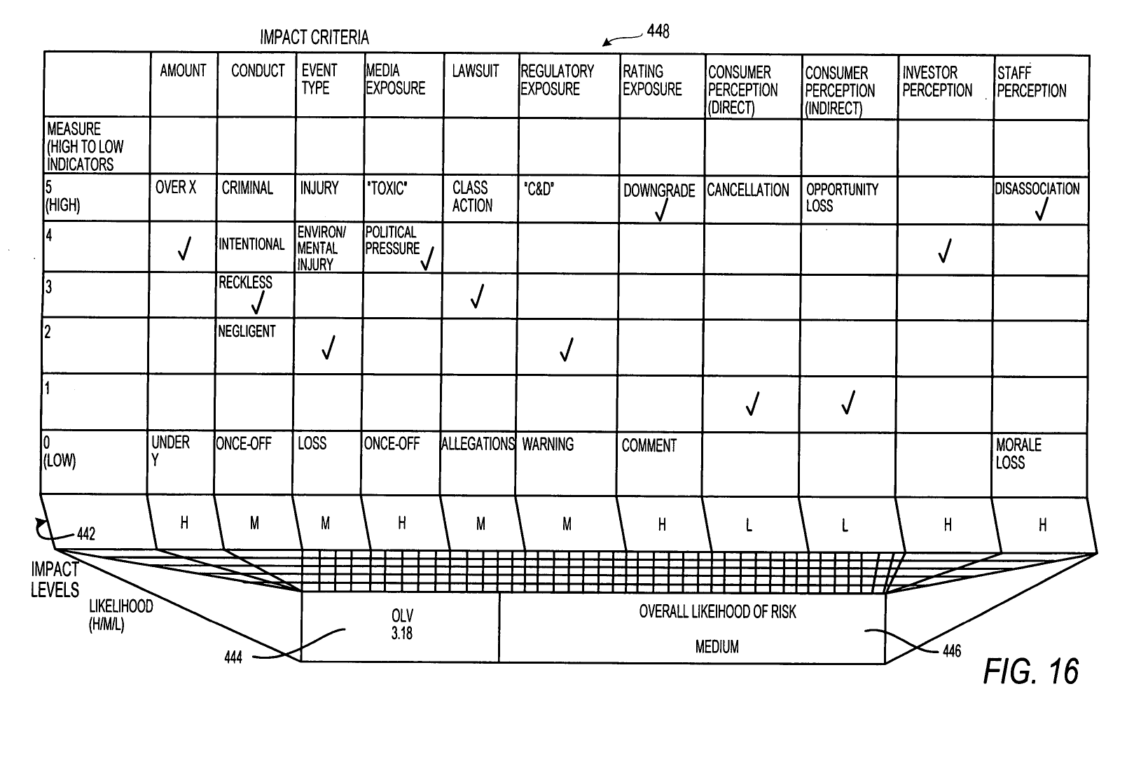

In an example determination of likelihood values, if the Conduct factor is determined to be Intentional, corresponding to a measured value of 4, the likelihood value of the Conduct factor is set to HIGH, while if the Regulatory Exposure factor is determined to be only a Warning, corresponding to a measured value of 0, the likelihood value of the Regulatory Exposure factor is set to LOW. Accordingly, the corresponding entry for the Conduct factor having a value of “4” may be checked or otherwise indicated in box 434, while the corresponding entry for the Regulatory Exposure factor having a value of “0” may be checked or otherwise indicated in box 436. Therefore, an H may be placed in box 438 corresponding to the checked box 434, and an L may be placed in box 440 corresponding to the checked box 436. An example filled in and check-off matrix is shown in FIG. 16.

Such likelihood values are entered in the row 442 at the bottom of the matrix 428 in FIG. 15. The interactive risk management system 10 and method may further process the likelihood value in row 442 for all impact criteria in row 430 to generate an overall likelihood value (OLV), which may be displayed in box 444 using, for example, Boolean logic, predetermined formulae, and/or fuzzy logic. A message of HIGH, MEDIUM, or LOW corresponding to the OLV in box 444 may optionally be generated and displayed in box 446.

In the example filled-in matrix 448 shown in FIG. 16, each HIGH likelihood value in row 442 may be assigned a predetermined numerical value of 1, each MEDIUM likelihood value in row 442 may be assigned a numerical value of 0.5, and each LOW likelihood value in row 442 may be assigned a predetermined numerical value of 0. Using a predetermined likelihood equation:

$$OLV = \frac{5 {\sum }_{∀ i} {L}_{i}}{N}$$

where OLV is the overall numerical likelihood value associated with all of the risk factors in the matrix, Lᵢ is the numerical likelihood value in row 442 for risk factor i, and N is the number of risk factors, such as the factors listed in row 430. The “5” in the likelihood equation corresponds to the maximum value in the measurement range of 0 to 5 in column 432 for normalization of the OLV in the likelihood equation and in box 444 to be in the same measurement range. In alternative embodiments, the predetermined likelihood equation may use a weighted average of the numerical likelihood values; for example, to weight the HIGH risk factors more than the MEDIUM or LOW risk factors in order that a majority of MEDIUM or LOW risk factors do not numerical overwhelm any HIGH risk factors.

The likelihood equation normalizes the sum of the numerical values to be between 0 and 5, inclusive, and so the final evaluation value may then be transformed to a text message using a predetermined message mapping of HIGH if 4≦OLV≦5; MEDIUM if 2≦OLV<4; and LOW if 0≦OLV<2. For the example filled-in matrix 448 illustrated in FIG. 16, with N=11 as the number of predetermined risk factors in row 430, with five evaluated HIGH risk factors, four evaluated MEDIUM risk factors, and two evaluated LOW risk factors as shown in row 442, the numerical overall likelihood value of risk factors for the institution corresponding to the filled-in matrix 448 in FIG. 16 is about 3.18 rounded, for example, to two decimal places. Such a numerical overall likelihood value corresponds to an overall likelihood value of MEDIUM for the institution having the risk factors shown in the matrix 448 in FIG. 16. The interactive risk management system 10 and method may display the numerical OLV, such as 3.18 in box 444 in FIG. 16, and/or may generate a text message of HIGH, MEDIUM, or LOW corresponding to the predetermined message mapping, as shown in box 446 in FIG. 16.

In an alternative embodiment, the interactive risk management system 10 and method may employ multi-value logic with logic values corresponding to HIGH, MEDIUM, and LOW text messages, such that the evaluation of likelihood of reputation risk is performed using multi-valued logic processing known in the art; for example, to avoid numerical incongruities at the limits of computing such as an OLV of 3.99 being determined to be MEDIUM risk likelihood, when the risk likelihood is significantly close to 4 being a HIGH risk likelihood. In further embodiments, the numerical OLV may be rounded up to the nearest integer on the scale from 0 to 5 prior to generating the risk likelihood message. Accordingly, a numerical OLV of 3.18 or 3.99 is rounded up to 4, and so the risk likelihood is determined to be HIGH, instead of MEDIUM.

The interactive risk management system 10 and method may output the likelihood values as data or text messages on a display for review by the user; for example, in the display of the impact measurement analysis matrix 448 on a screen of the display 16. Using the interactive risk management system 10 and method in conjunction with the reputation risk management analysis system, the user may manage and/or reduce the reputation risk of an entity, such as an institution including banks, brokerages, charities, hospitals, etc.

### Metrics Analysis

In operation, the interactive risk management system 10 and method analyzes reputation risk by incorporating and using values for a plurality of reputation risk factors, for example, in the matrices 428, 448 as shown in FIGS. 15-16, respectively, which are rated HIGH, MEDIUM, or LOW according to a likelihood scale. For manual input or for manual overriding of automatic input of data completing the matrix 448, the user fills in the appropriate risk level in the likelihood scale for a given factor according to the values in Table 1.

TABLE 1

| Likelihood Scale | Risk Level |
|---|---|
| Rare/once-off | LOW |
| Recurring | MEDIUM |
| Often/Immediate | HIGH |

In another embodiment, the interactive risk management system 10 and method may incorporate and take into account other factors and indicators affecting reputation risk including, for example, industry factors, ranked HIGH, MEDIUM, or LOW, such as:

A) the level of visibility in industry; for example, whether the institution is a market leader or participant, and whether the institution defines the Best Practices for the industry;

B) whether a reputation risk event arises in a key product or service area;

C) the level of peer group reputation risks; that is, whether a particular reputation risk has occurred to other key players in the relevant or same market;

D) the frequency of peer reputation risk events; that is, whether particular reputation risk event has been a frequent or isolated industry reputation risk event; and

E) the level of direct customer exposure; for example, whether the institution is directly interfacing with customers or have secondary or hidden customer exposure.

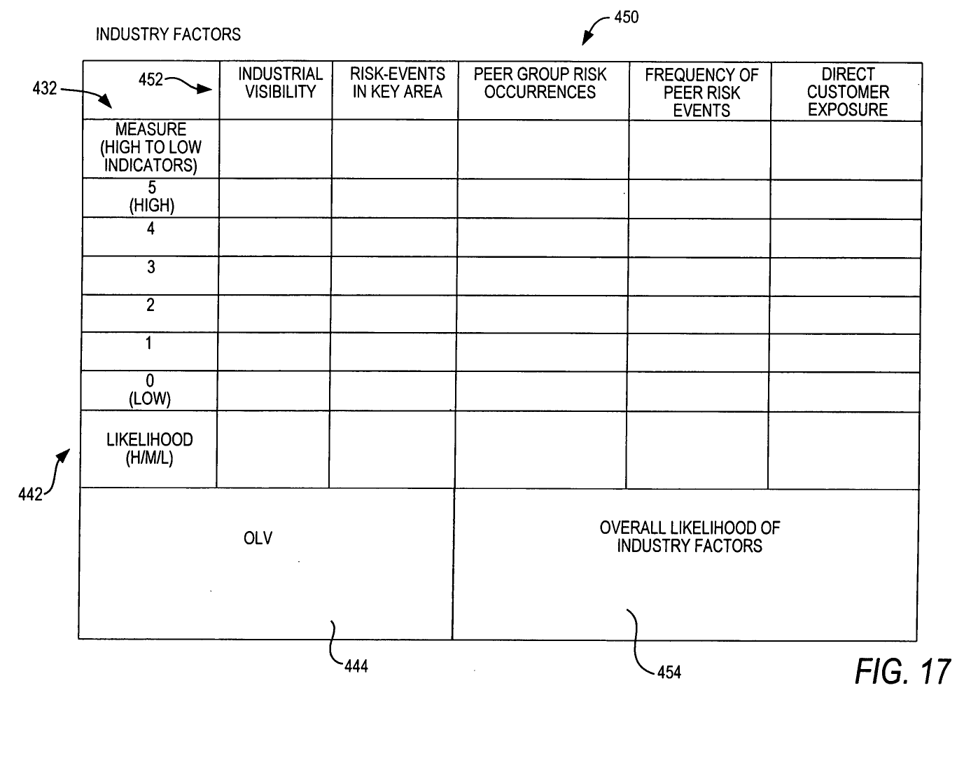

These factors may be evaluated using an industry factor matrix 450 shown in FIG. 17 and displayed on the display 16, using automatic entry of data and/or manual input of data using the input device 14, to generate likelihoods of risk according to predetermined industry issues in the row 452, in a manner identical to the generation of likelihoods described herein in connection with FIGS. 15-16. Using filled-in measures in the rows corresponding to the measurement indicators in column 432, the respective likelihoods of risk for each issue is generated in row 442, an OLV based on the likelihoods in row 442 may be generated and displayed in box 444, and an overall likelihood of industry factors affecting reputation risk may also be generated and displayed din box 454.

After the matrices 428, 450 in FIGS. 15 and 17, respectively, are completed with the most information available, and the likelihoods are filled in along the rows and columns, the interactive risk management system 10 and method generate an exposure evaluation according to the reputation risk exposure table shown in Table 2, by which, for a given case, the presence of a number of HIGH values in row and an overall likelihood value of HIGH or MEDIUM/LOW, as well as factoring in the overall industrial factor of HIGH, MEDIUM, or LOW, determines the exposure of the institution for a given risk factor.

TABLE 2

| | | |
|---|---|---|
| Particular Risk Factor | Industry Factors | Exposure |

Case 1: Two or more HIGH risk factors,
and an overall risk likelihood of HIGH

| | | |
|---|---|---|
| HIGH | HIGH | Major |
| HIGH | MEDIUM | Major |
| HIGH | LOW | Significant |

Case 2: Two or more HIGH risk factors,
and an overall risk likelihood of MEDIUM/LOW

| | | |
|---|---|---|
| HIGH | HIGH | Significant |
| HIGH | MEDIUM | Medium |
| HIGH | LOW | Medium |

Case 3: One or less HIGH risk factors,
and an overall risk likelihood of HIGH

| | | |
|---|---|---|
| MEDIUM | HIGH | Significant |
| MEDIUM | MEDIUM | Medium |
| MEDIUM | LOW | Medium |

Case 4: One or less HIGH risk factors,
and an overall risk likelihood of MEDIUM/LOW

| | | |
|---|---|---|
| HIGH | HIGH | Medium |
| HIGH | MEDIUM | Medium |
| HIGH | LOW | Limited |

As shown in Table 2, the exposure ratings are set within four ranges. For Major exposure, these reputation risks must be treated on an immediate, first priority basis with the direct involvement of the highest levels of senior management. Full and immediate remediation is required. The presence of reputation risk “accelerators”, described herein, underscore the need for high priority remediation.

For Significant exposure, these reputation risks require immediate review and attention of a designated reputation risk response team. Such reputation risks should be noticed to senior management which should track for successful remediation.

For Medium exposure, these issues, if not remediated, have the potential to become reputation risk issues. Such issues should be noted, studied, and monitored to ensure that these issues do not become more problematic. These issues should be logged for remedial action.

For Limited exposure, these are issues that should be logged and reviewed. Discussions should be ongoing between primary and secondary control areas regarding the origin of the issue and potential resolutions.

Upon such determinations of levels of exposure, the interactive risk management system 10 and method may optionally generate and output to the institution any of such messages in connection with remediation, including notices to senior management and such logging of issues for remediation.

### Remediation of Reputation Risk

In addition to determining risk levels and likelihoods of exposure, the interactive risk management system 10 and method may be used for remediation of issues affecting reputation risk, and may be implemented in the risk response 416 in FIG. 13 and the solutions 426 for risk reduction in FIG. 14. Once real or potential reputation risks have been identified, solution methodologies are developed, for example, drawing from predetermined solutions to identical or similar reputation risks, with such predetermined solutions being stored in the memory 22. Such solutions may include a focused and/or immediate resolution of identified risk issues which give rise to potential reputation risk; and product, service, governance, or control solutions in the primary or secondary control areas to ensure that similar reputation risks do not re-occur in the future. The presence of reputation risk “Moderators”; that is, “Accelerators” and “Mitigators”, as described herein, are important factors in defining the level of remedial response required.

Accelerators are factors which heighten the requirement for prompt remedial action, such as reputation risk structure and controls which are not in place, capital constraints, prior reputation risk events which may create a “snowball effect” on the reputation of the institution, and continuing “medium” risks.

Mitigators are factors which contribute to a controlled level of remediation, such as reputation risk cultural awareness, prompt placement of reputation risk remediation structures, and capital resiliency/capital adequacy.

Using the interactive risk management system 10 and method, the presence or absence of such accelerators and mitigators may be noted and tracked, for example, in the actions plans, implementation, and monitoring of the risk response 416 for use in addressing and remediation of reputation risks identified by the interactive risk management system 10 and method.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

What is claimed is:

1. An interactive risk management system comprising:
a computer including:
a processor;
an input device;
a display for displaying a graphic user interface including a browser;
a memory; and
a mapping of a plurality of processes and at least one risk message associated with at least one of the plurality of processes stored in the memory;
wherein the processor, in response to user selections through the input device, displays to the user through the browser the mapping of the plurality of processes, with each of a set of the displayed processes having an associated user actuatable display region;
wherein the processor, in response to user actuation of an actuatable display region of a selected process, displays to the user through the browser the at least one risk message associated with the selected process, thereby allowing the user to gain information about the selected process and its associated risks; and
wherein the processor, in response to the at least one risk message and risk information, performs reputation risk management analysis on the at least one risk message using a predetermined metric to generate and display impact level data.

2. The interactive risk management system of claim 1, wherein the memory is accessible through a computer network, whereby any user, using the browser and communicating via the computer network, may access and view the mapping and may actuate the actuatable display regions to selectively view the at least one risk message.

3. The interactive risk management system of claim 2, wherein the computer network is an intranet.

4. The interactive risk management system of claim 2, wherein the computer network is the Internet.

5. The interactive risk management system of claim 1, wherein the actuatable display regions are associated with link data addressing linkable data stored in the memory; and
wherein the processor, in responsive the actuation of a selective actuatable display region, communicates with the memory via a respective link data to retrieve the corresponding linkable data.

6. The interactive risk management system of claim 5, wherein the link data is a hyperlink.

7. The interactive risk management system of claim 1, wherein the processor generates an impact measurement analysis matrix on the display to perform reputation risk management analysis by identifying impact levels corresponding to a plurality of reputation risk factors.

8. The interactive risk management system of claim 7, wherein the processor generates and displays in the displayed impact measurement analysis matrix a plurality of risk likelihood values, with each risk likelihood value corresponding to a respective one of the plurality of reputation risk factors.

9. The interactive risk management system of claim 8, wherein the processor determines an overall likelihood value from the plurality of risk likelihood values using the predetermined metric.

10. The interactive risk management system of claim 8, wherein the processor determines an exposure value corresponding to a degree of exposure of an institution from the plurality of risk likelihood values using the predetermined metric.

11. An interactive risk management method for providing risk information associated with one or more of a plurality of processes, the method comprising the steps of:
providing a computer including a processor, an input device, a display, and a memory;
displaying a graphic user interface including a browser on the display;
storing in the memory a mapping of a plurality of processes;
storing in the memory at least one risk message associated with at least one of the plurality of processes;
receiving at the processor user command signals entered through the input device;
displaying to the user through the browser the mapping of the plurality of processes, with each of a set of the displayed processes having an associated actuatable display region;
receiving at the processor signals corresponding to user actuation of an actuatable display region of a selected process;
performing reputation risk management on the at least one risk message and risk information using a predetermined metric to generate and display impact level data; and
displaying to the user through the browser, in response to the user actuation, the at least one risk message associated with the selected process, thereby allowing the user to gain information about the selected process and any associated risk.

12. The interactive risk management method of claim 11, further comprising the steps of:
providing a memory accessible through a computer network by users using a browser connected to the computer network;
communicating command signals through the computer network to access and display to the user the mapping; and
actuating the actuatable display regions to selectively view the at least one risk message.

13. The interactive risk management method of claim 11, wherein the computer network is an intranet.

14. The interactive risk management method of claim 11, wherein the computer network is the Internet.

15. The interactive risk management method of claim 11, further comprising the steps of:
associating actuatable display regions with link data addressing linkable data stored in the memory;
responding at the processor to actuation of a selective actuatable display region to communicate with the memory via a respective link data; and
retrieving the corresponding linkable data.

16. The interactive risk management method of claim 15, wherein the link data is a hyperlink.

17. The interactive risk management method of claim 11, further comprising the steps of:
generating an impact measurement analysis matrix using the processor;
displaying on the display the impact measurement analysis matrix;
receiving input data into the impact measurement analysis matrix; and
performing reputation risk management analysis using the processor processing the input data for identifying impact levels corresponding to a plurality of reputation risk factors.

18. The interactive risk management method of claim 17, wherein the step of displaying the impact measurement analysis matrix includes the step of:
displaying in the displayed impact measurement analysis matrix a plurality of risk likelihood values, with each risk likelihood value corresponding to a respective one of the plurality of reputation risk factors.

19. The interactive risk management method of claim 18, further comprising the step of:
determining an overall likelihood value from the plurality of risk likelihood values by the processor using the predetermined metric.

20. The interactive risk management method of claim 18, further comprising the step of:
determining an exposure value corresponding to a degree of exposure of an institution from the plurality of risk likelihood values by the processor using the predetermined metric.
